(19) United States
(12) Patent Application Publication
(10) Pub. No.: US 2024/0146754 A1
(43) Pub. Date: May 2, 2024

(54) NETWORK SECURITY

(71) Applicant: BRITISH TELECOMMUNICATIONS PUBLIC LIMITED COMPANY, LONDON (GB)

(72) Inventors: Daniel BASTOS, London (GB); Fadi EL-MOUSSA, London (GB)

(21) Appl. No.: 18/574,644

(22) PCT Filed: Jun. 21, 2022
(86) PCT No.: PCT/EP2022/066815

§ 371 Date: Dec. 27, 2023

(30) Foreign Application Priority Data
Jun. 29, 2021 (GB) 2109365.3

(51) Int. Cl. H04L 9/40; H04L 41/16

(52) U.S. Cl. CPC H04L 63/1425; H04L 41/16

(57) ABSTRACT

A method includes, at a processor-controlled device of a network, identifying a first portion of a data transmission transmitted via the network that is indicative of an anomaly. A second, different, portion of the data transmission including personal data is identified. The data transmission is modified to generate a modified data transmission, the modifying the data transmission comprising selectively anonymizing one or more portions of the data transmission such that at least the second portion of the data transmission is anonymized. The modified data transmission is sent to a remote system for identification of whether the first portion of the data transmission is indicative of malicious behavior.

### PRIORITY CLAIM

The present application is a National Phase entry of PCT Application No. PCT/EP2022/066815, filed Jun. 21, 2022, which claims priority from GB Application No. 2109365.3, filed Jun. 29, 2021, each of which hereby fully incorporated herein by reference.

### TECHNICAL FIELD

The present disclosure relates to improving network security.

### BACKGROUND

Despite measures to improve security, cyber-attacks on networks are increasing. This risks sensitive data being exposed to malicious parties. Intrusion detection systems can be used to identify ongoing or previous attacks, or to identify vulnerabilities that may increase the risk of an attack. The data used to perform known intrusion detection techniques, such as logs of network activity, may include or otherwise indicate personal information about users of devices on a network. For example, if a network log indicates that the volume of traffic transmitted by a particular device increases at a certain time of the day, it could be inferred that the user is performing a particular activity, which involves use of the particular device, at that time of the day. This can compromise the security of the environment in which the device is located. For example, if the device is located at a user's home, a malicious party may be able to infer when the user is likely to be out of their home, and hence when the home is more vulnerable to burglary.

Given the privacy concerns associated with sharing data for intrusion detection, such data may not be shared with intrusion detection systems or teams, such as incident response or security operations teams, which can hamper their ability to identify and mitigate threats.

It is desirable to at least alleviate some of the aforementioned problems.

### SUMMARY

According to a first aspect of the present disclosure there is provided a method comprising, at a processor-controlled device of a network: identifying a first portion of a data transmission transmitted via the network that is indicative of an anomaly; identifying a second portion of the data transmission comprising personal data, the second portion different from the first portion; modifying the data transmission to generate a modified data transmission, the modifying the data transmission comprising selectively anonymizing one or more portions of the data transmission such that at least the second portion of the data transmission is anonymized; and sending the modified data transmission to a remote system for identification of whether the first portion of the data transmission is indicative of malicious behavior.

In some examples, modifying the data transmission comprises selectively encrypting one or more portions of the data transmission such that at least the first portion of the data transmission is encrypted. In some of these examples, the method may include identifying a third portion of the data transmission, different from the first and second portions of the data transmission, wherein the first portion of the data transmission is encrypted using a first encryption protocol, and the third portion of the data transmission is encrypted using a second encryption protocol, different from the first encryption protocol. The first portion of the data transmission may be encrypted using attribute-based encryption.

In some examples, the first portion of the data transmission comprises further personal data.

In some examples, the data transmission is transmitted via the network to and/or from a user device of the network.

In some examples, the processor-controlled device is a gateway of the network.

In some examples, the data transmission comprises a packet, the first portion of the data transmission comprises a first field of the packet and the second portion of the data transmission comprises a second field of the packet, different from the first field.

In some examples, the method comprises, after sending the modified data transmission to the remote system, receiving, from the remote system, an indication that a determination has been made that the data transmission is indicative of malicious behavior, wherein optionally the indication comprises a policy to mitigate the malicious behavior.

In some examples, identifying the first portion of the data transmission comprises processing the data transmission using a machine learning system implemented by the processor-controlled device. In some of these examples, identifying the first portion of the data transmission comprises processing the data transmission, and traffic data indicative of network traffic activity associated with a plurality of data transmissions transmitted via the network, using the machine learning system. In some of these examples, the machine learning system is configured to determine, upon processing the data transmission, a type of anomaly present in the data transmission, and identifying the first portion of the data transmission comprises identifying that the first portion of the data transmission is relevant to the type of anomaly. In some of these examples, the data transmission comprises a plurality of portions, comprising the first portion and the second portion, each of the plurality of portions associated with a respective weight, and processing the data transmission using the machine learning system comprises processing each of the plurality of portions using the respective weight.

In some examples, the method comprises identifying the first portion of the data transmission based further on an access policy associated with the remote system.

According to a second aspect of the present disclosure, there is provided a computer-implemented method comprising: receiving, from a processor-controlled device of a network, a received data transmission associated with a data transmission transmitted via the network, the received data transmission comprising: data derived from a first portion of the data transmission; and an anonymized second portion of the data transmission, wherein the received data transmission is indicative that the data derived from the first portion of the data transmission is for use in identifying malicious behavior; processing the data derived from the first portion of the data transmission to identify that the first portion of the data transmission is indicative of malicious behavior; and sending, to the processor-controlled device, an indication that the first portion of the data transmission is indicative of the malicious behavior.

In some examples, a format of the data derived from the first portion of the data transmission is indicative that the data derived from the first portion of the data transmission is for use in identifying malicious behavior. In some of these examples, the data derived from the first portion of the data transmission is an encrypted version of the first portion of the data transmission, encrypted using a predetermined encryption protocol, and the data derived from the first portion of the data transmission is identified as being for use in identifying malicious behavior based on identifying that the first portion of the data transmission is encrypted using the predetermined encryption protocol. The predetermined encryption protocol may be attribute-based encryption. In some of these examples, processing the data derived from the first portion of the data transmission comprises decrypting the encrypted version of the first portion of the data transmission to generate a decrypted version of the first portion of the data transmission, and processing the decrypted version of the first portion of the data transmission to identify that the first portion of the data transmission is indicative of the malicious behavior. In some of these examples, the received data transmission comprises a third portion encrypted using a further encryption protocol different from the predetermined encryption protocol.

In some examples, the data transmission is a first data transmission, the received data transmission is a first received data transmission received from a first processor-controlled device, and the method comprises: receiving, from a second processor-controlled device of the network, a second received data transmission associated with a second data transmission transmitted via the network, the second received data transmission comprising: data derived from a first portion of the second data transmission; and an anonymized second portion of the second data transmission, wherein the second received data transmission is indicative that the data derived from the first portion of the second data transmission is for use in identifying malicious behavior, wherein processing the data derived from the first portion of the first data transmission comprises processing the data derived from the first portion of the first data transmission and the data derived from the first portion of the second data transmission to identify that the first portions of the first and second data transmissions are indicative of malicious behavior, and wherein the method further comprises sending, to the second processor-controlled device, an indication that the first portion of the second data transmission is indicative of the malicious behavior.

According to a third aspect of the present disclosure, there is provided a processor-controlled device comprising: at least one processor; and storage comprising computer program instructions which, when processed by the at least one processor, cause the processor-controlled device to: identify a first portion of a data transmission transmitted via the network that is indicative of an anomaly; identify a second portion of the data transmission comprising personal data, the second portion different from the first portion; modify the data transmission to generate a modified data transmission, the modifying the data transmission comprising selectively anonymizing one or more portions of the data transmission such that at least the second portion of the data transmission is anonymized; and send the modified data transmission to a remote system for identification of whether the first portion of the data transmission is indicative of malicious behavior. The processor-controlled device may be a gateway of the network.

According to a fourth aspect of the present disclosure, there is provided a computer system comprising: at least one processor; and storage comprising computer program instructions which, when processed by the at least one processor, cause the computer system to: receive, from a processor-controlled device of a network, a received data transmission associated with a data transmission transmitted via the network, the received data transmission comprising: data derived from a first portion of the data transmission; and an anonymized second portion of the data transmission, wherein the received data transmission is indicative that the data derived from the first portion of the data transmission is for use in identifying malicious behavior; process the data derived from the first portion of the data transmission to identify that the first portion of the data transmission is indicative of identifying malicious behavior; and send, to the processor-controlled device of the network, an indication that the first portion of the data transmission is indicative of the identifying malicious behavior.

According to a fifth aspect of the present disclosure, there is provided a network comprising the processor-controlled device of any example in accordance with the third aspect of the present disclosure, and the computer system of any example in accordance with the fourth aspect of the present disclosure.

### BRIEF DESCRIPTION OF THE DRAWINGS

For a better understanding of the present disclosure, reference will now be made by way of example only to the accompany drawings, in which:

FIG. 1 is a schematic diagram showing use of a system to identify malicious behavior according to examples.

FIG. 2 is a schematic diagram showing use of the system of FIG. 1 to mitigate identified malicious behavior.

FIG. 3 is a schematic diagram of data transmissions according to examples.

FIG. 4 is a schematic diagram of a machine learning system for identifying anomalies in data transmissions.

FIGS. 5a and 5b are schematic diagrams illustrating the treatment of various portions of two of the data transmissions of FIG. 3.

FIG. 6 is a schematic diagram showing internal components of an example data processing system.

### DETAILED DESCRIPTION

Apparatus and methods in accordance with the present disclosure are described herein with reference to particular examples. The disclosure is not, however, limited to such examples.

Examples herein involve identifying, at a processor-controlled device of a network, a first portion of a data transmission transmitted via the network that is indicative of an anomaly. An anomaly for example indicates that the data transmission is unusual or has at least one characteristic that deviates from an expected characteristic of the data transmission. However, anomalous data transmissions may not originate from a malicious source.

Instead, an anomaly may be benign, for example if a user starts to use a device sending data transmissions to the processor-controlled device in a different way from that used previously. In some cases, though, an anomalous data transmission is indicative that a malicious party is attempting to attack the network and/or a device connected to the network. For example, the anomalous data transmission may indicate that a malicious party has gained unauthorized access to an Internet of Things (IoT) device connected to a home network, causing the IoT device to send anomalous data transmissions to the processor-controlled device of the home network (which may be e.g. a gateway device of the home network). It is hence important to identify whether data transmissions initially identified as anomalous are indicative of malicious or benign behavior, and thus whether to take mitigating action or not. It is to be appreciated that, in this context, unauthorized access to the network or a device connected to the network is to be considered malicious.

In examples herein, the data transmission is modified to generate a modified data transmission. The modification involves selectively anonymizing one or more portions of the data transmission, such that at least a second, different, portion of the data transmission that comprises personal data is anonymized. Selective anonymization for example refers to anonymizing less than all of the data transmission. For example, the first portion of the data transmission (which is indicative of the anomaly) may not be anonymized, to facilitate or simplify further analysis of the modified data transmission. The modified data transmission is then sent to a remote system, such as a remote intrusion detection system, which may be or include an incident response or security operations system, to identify whether the first portion of the data transmission is indicative of malicious behavior. In this way, the unanonymized personal data is not shared with the remote system, to avoid compromising the privacy of a user of the device involved in sending or receiving the data transmission. Sending the modified data transmission to the remote system, however, allows the remote system to further investigate a potential threat posed by the data transmission, to identify whether the anomaly is malicious or not. This approach can improve the detection of threats compared to other approaches. For example, the analysis performed by the remote system may be more sophisticated and/or complex than the anomaly detection performed by the processor-controlled device (which may be limited by the storage and/or processing capability of the processor-controlled device, which is typically lower than that of the remote system). Moreover, in some cases, the remote system may collate information on potential anomalies identified by various processor-controlled devices, which may allow patterns in anomalous behavior to be identified as malicious behavior more effectively than analyzing anomalous behavior of each device separately. In such cases, the remote system can hence use the aggregated information to coordinate an appropriate response to a potential threat that can be deployed to a plurality of processor-controlled devices, for example.

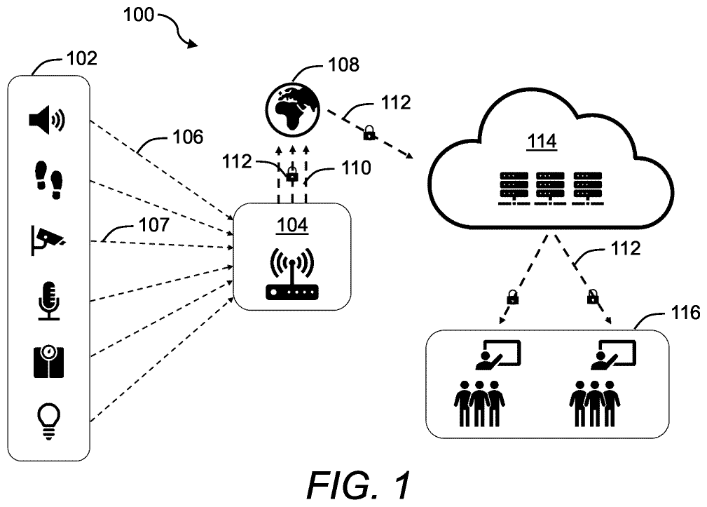

FIG. 1 is a schematic diagram showing use of a system 100 to identify malicious behavior according to examples. The system 100 includes a plurality of user devices 102, which in this example are Internet of Things (IoT) devices. An IoT device is for example a device with the means to communicate data within its environment, e.g. over a network local to the environment. IoT devices can be included in the Internet of Things, which is a network of user devices such as home appliances, vehicles and other items embedded with electronics, software, sensors, actuators, and/or connectivity which enable these devices to connect with each other and/or other computer systems and exchange data. Examples of IoT devices include smart light bulbs, smart cameras, smart doorbells, connected refrigerators, smart televisions (TVs) and voice assistant devices.

In the system 100 of FIG. 1, the user devices 102 are in communication with a processor-controlled device 104, which involves the sending of data transmissions (indicated by dashed arrows from the user devices 102 to the processor-controlled device 104, one of which is labelled with the reference numeral 106) to the processor-controlled device 104. For example, a given user device 102 may obtain measurements or other data, which may be transmitted to a remote server for analysis or other processing. Although not shown in FIG. 1, it is to be appreciated that the processor-controlled device 104 may be in two-way communication with respective user devices, and may therefore also send data transmissions to respective user devices. For example, in response to receiving data from a particular user device, a remote server may transmit instructions to the user device via the processor-controlled device 104. In FIG. 1, the data transmissions include an anomalous data transmission 107, which is between a smart camera and the processor-controlled device 104.

The processor-controlled device 104 provides a network, which in this example is a local network, such as home network. For example, the processor-controlled device 104 may be a home router, such as a home hub, of the home network, or another device to provide an entry point to the network or to filter and/or route network traffic, such as a gateway, switch, hub, access point or an edge device (which may be or comprise a router or routing switch). It is to be appreciated that, in general, a processor-controlled device such as that shown in FIG. 1 is for example any device controlled by a processor, such as a computer.

The user devices 102 are connected to the network provided by the processor-controlled device 104. The processor-controlled device 104 can be connected to a further network. The further network may be a single network or may include a plurality of networks. The further network may be or include a wide area network (WAN), a local area network (LAN) and/or the Internet, and may be a personal or enterprise network. In this case, the processor-controlled device 104 is connected to the Internet 108, and can hence send further data transmissions to at least one remote system via the Internet 108. The further data transmissions are indicated schematically in FIG. 1 using dashed arrows from the processor-controlled device 104 to the Internet 108, one of which is labelled with the reference numeral 110.

In this example, the processor-controlled device 104 is configured to generate a modified data transmission 112 as explained above, which includes a first portion of a data transmission between a user device 102 and the processor-controlled device 104 that is identified by the processor-controlled device 104 as anomalous (which in this case is the anomalous data transmission 107). The modified data transmission 112 also includes an anonymized second portion of the anomalous data transmission 107, which has been modified to anonymize personal data of the second portion of the data transmission 106. The further data transmissions 110 in this case include the modified data transmission 112.

The modified data transmission 112 is sent, via the Internet 108, to a remote system 114 for identification of whether the first portion of the data transmission is indicative of malicious behavior. In this case, the remote system 114 is remote from the processor-controlled device 104 in the sense that it is not located on the local network provide by the processor-controlled device 104, however it is to be appreciated that the remote system 114 may also or instead be remote in a different sense, e.g. physically remote. The remote system 114 is for example a cloud computing system. In some examples, the remote system may be suitably configured to identify whether the first portion of the data transmission (as included in the modified data transmission 112) is indicative of malicious behavior. However, in the example system 100 of FIG. 1, the remote system 114 sends the modified data transmission 112 to teams of security analysts 116 to analyze the first portion of the data transmission to identify whether it is indicative of malicious behavior.

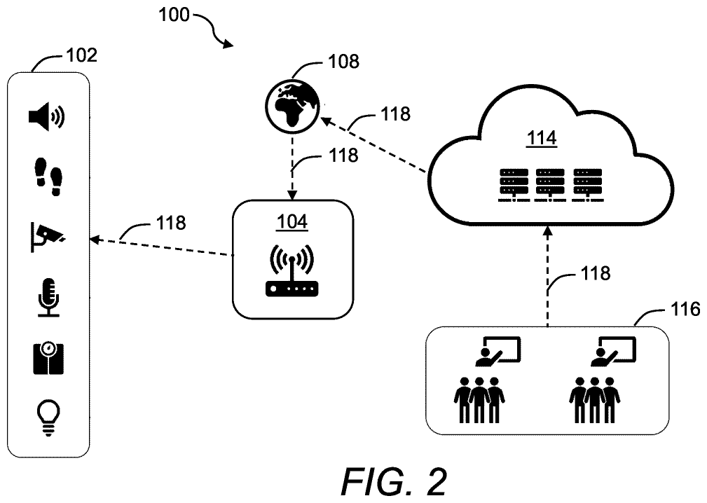

FIG. 2 is a schematic diagram showing use of the system 100 of FIG. 1 to mitigate identified malicious behavior. Features of FIG. 2 that are the same as corresponding features of FIG. 1 are labelled with the same reference numeral. Upon receipt of the modified data transmission 112 by the security analysts 116, the security analysts 116 investigate the first portion of the data transmission (which is included in the modified data transmission), either alone or in conjunction with other data transmission(s) including respective portions that have been identified as being anomalous, and classify the data transmission as malicious, not malicious (e.g. benign), or inconclusive (e.g. if the first portion of the data transmission is insufficient for the security analysts 116 to be adequately certain that the data transmission is indeed malicious).

In the example of FIG. 2, the security analysts 116 analyze the modified data transmission 112 shown in FIG. 1 and determine that the first portion of the data transmission (which in this case is the anomalous data transmission 107 of FIG. 1) indicates anomalous behavior. In this case, the analysis performed by the security analysts 116 reveals that a legitimate web service has been hijacked, which has allowed a malicious party to target the smart camera and use telnet commands to perform malicious activities. The data transmission is for example a telnet command used by the malicious party.

The security analysts 116 send an indication 118 to the remote system 114 that it has been determined that the data transmission is indicative of malicious behavior. In some cases, the indication 118 may be a message or other alert to indicate that malicious behavior has been detected. A device that receives the indication 118 (e.g. the remote system 114 and/or the processor-controlled device 104) can then determine appropriate action to take to mitigate the malicious behavior. An alert may also or instead be sent to a user of a device, e.g. to a smartphone, tablet or laptop computer associated with a user of the user device 102 participating in the anomalous data transmission, so as to alert the user of the threat. The user can then take action to protect the system 100 from the threat, e.g. by switching off the user device 102 participating in the anomalous data transmission.

In addition or alternatively, the indication 118 may include a policy to be implemented by the processor-controlled device 104, the user device that participated in the anomalous behavior and/or at least one other user device to mitigate the malicious behavior. Such a policy may for example be or include suitable instructions to configure a device to mitigate the malicious behavior. For example, the policy may be pushed to the processor-controlled device 104 to block data transmissions received from a particular user device (the smart camera in this case) or to disconnect the particular user device from the network provided by the processor-controlled device 104, indefinitely or until the user device has been made safe. Further examples include configuring the processor-controlled device 104 to block external domains and/or Internet Protocol (IP) addresses involved in the data transmission identified as being indicative of malicious behavior, and/or to reduce bandwidth availability for a particular user device connected to the network of the processor-controlled device 104 (e.g. to mitigate a ransomware attack). It is to be appreciated that these are merely examples, though, and a policy may represent other mitigating action(s) in other cases.

In FIG. 2, the remote system 114 sends the indication 118 via the Internet 108 to the processor-controlled device 104, which then sends the indication 118 to the user device 102 that participated in the anomalous data transmission (in this case, the smart camera). In other cases, the indication 118 may be sent by the processor-controlled device 104 to another device, such as another at least one of the user devices 102. For example, the analysis may indicate that the malicious behavior is a threat to another device. In such cases, the indication 118 (or a different indication) may be sent to the other device to alert the other device of the threat and/or to appropriately configure the other device to proactively protect the other device from the threat.

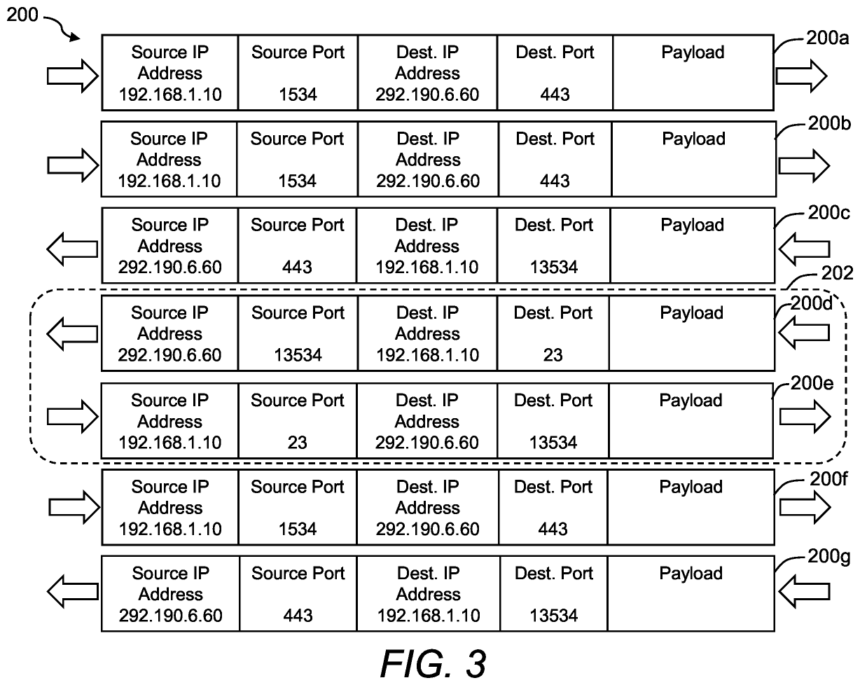

Referring now to FIG. 3, FIG. 3 is a schematic diagram of data transmissions 200 according to examples. The data transmissions 200 of FIG. 3 may be the same as or similar to the data transmissions 106 of FIG. 1. In FIG. 3, there are seven data transmission, labelled with reference numerals from 200a to 200g to indicate first to seventh data transmissions, respectively. However, this is merely an example.

In FIG. 3, each of the data transmissions is a packet, comprising a plurality of fields. In other cases, though, a data transmission may include a packet and other data and/or may be of a different format. Each packet of a data transmission 200 of FIG. 3 includes five fields: source IP address, source port, destination IP address, destination port and payload (which may be encrypted or in cleartext). Again, though, it is to be appreciated that this is merely an example. For example, a packet may also include fields indicating the payload size, the protocol used to encrypt the payload, and the packet size.

The data transmissions 200 of FIG. 3 correspond to example packets exchanged between a user device (such as the user devices 102 of FIGS. 1 and 2), which in this case is a smart camera, and an external web service, via a processor-controlled device (such as the processor-controlled device 104 of FIGS. 1 and 2). Arrows in a direction from left to right in FIG. 3 illustrate ingress traffic (traffic from the smart camera to the processor-controlled device), and arrows in a direction from right to left in FIG. 3 illustrate egress traffic (traffic from the processor-controlled device to the smart camera).

The data transmissions 200 are processed by the processor-controlled device to identify which of the data transmissions 200 indicate an anomaly. In FIG. 3, two of the data transmissions 200 are identified as anomalous data transmissions 202: a fourth and fifth data transmission 200d, 200e. Anomalous data transmissions that are identified by the processor-controlled device undergo a modification process that involves anonymizing personal data while retaining data indicative of an anomaly, to allow for further investigation remotely.

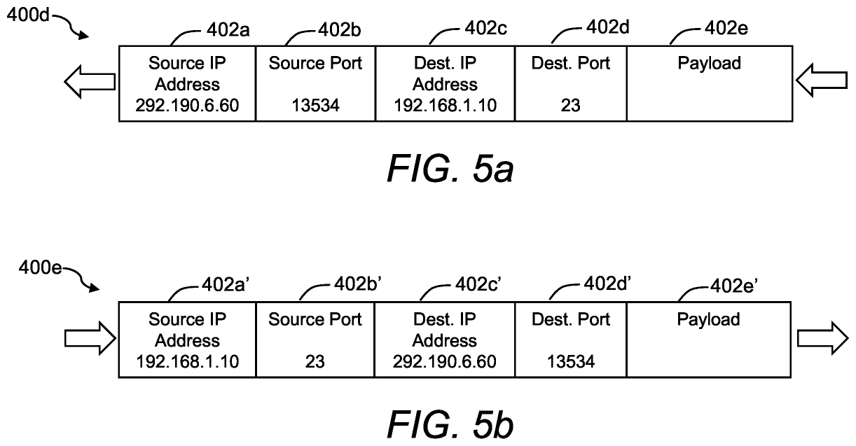

For an anomalous data transmission (in this case, each of the fourth and fifth data transmissions 200d, 200e), this for example further involves identifying a first portion of the data transmission that is indicative of the anomaly, so that this portion of the data transmission can be preserved, while anonymizing a second portion of the data transmission (different from the first portion) that includes personal data. This is discussed further with reference to FIGS. 5a and 5b.

As can be seen from FIG. 3, the anomalous data transmissions 202 in this case use a source or destination port of 23 (indicating usage of the telnet protocol for unencrypted text communications). This differs from the other data transmissions, which use a destination and source port of 1534, 443 or 13534 (which indicate other forms of communication). As the telnet protocol is an insecure service typically targeted by malware, usage of port 23 may indicate that an attack is occurring. A data transmission that has a source or destination port of 23 may hence be identified as being potentially anomalous, with the type of anomaly identified as abnormal port use. Identifying the type of anomaly present in a particular data transmission allows a first portion of the data transmission that is relevant to that type of anomaly (and which is e.g. indicative of the anomaly) to be identified. For example, where it is identified that the data transmission is indicative of abnormal port use, portions of the data transmission relating to port use (e.g. fields of a packet that relate to port use, such as source port and destination port) can be identified as the first portion of the data transmission. In some examples, anonymization of the first portion of the data transmission is omitted to simplify further analysis by a remote system.

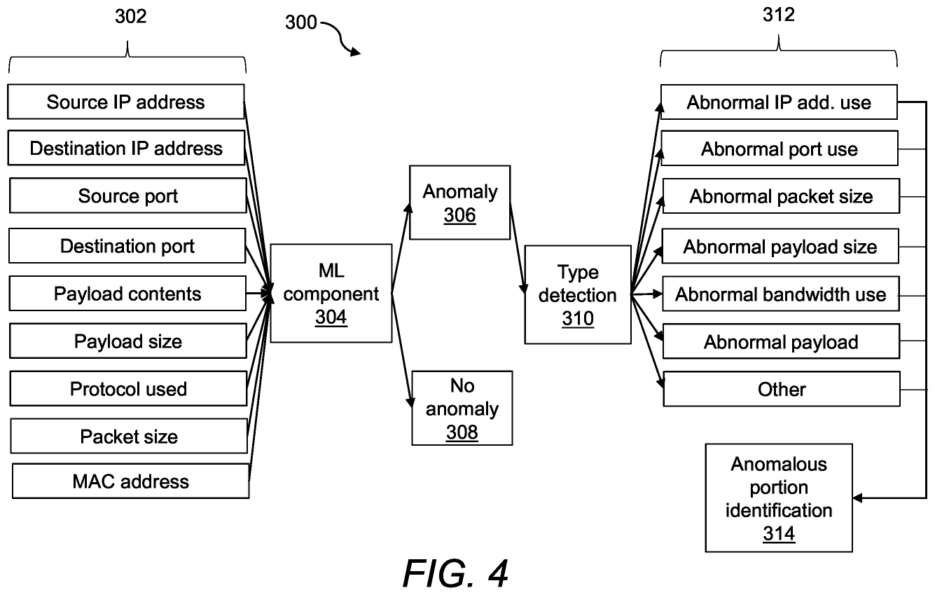

As the skilled person will appreciate, there are various known methods of anomaly detection that may be used to identify anomalous data transmissions. FIG. 4 is a schematic diagram of a machine learning (ML) system 300 for identifying anomalies in data transmissions according to examples herein, e.g. to identify a first portion of a data transmission indicative of an anomaly. An ML system such as that of FIG. 4 may for example be implemented by the processor-controlled device.

In FIG. 4, the ML system 300 processes a data transmission 302, which may be similar to any of the data transmissions discussed herein, such as the data transmissions 200 shown in FIG. 3. In this case, the data transmission 302 corresponds to data transmitted from a smart camera to a gateway (which is an example of a processor-controlled device). Similarly to the data transmissions 200 of FIG. 3, the data transmission 302 of FIG. 4 includes fields indicative of a source IP address, a destination IP address, a source port, a destination port and payload contents, respectively. However, the data transmission 302 of FIG. 4 also includes further fields indicative of a payload size, a protocol used to encrypt the payload contents, a packet size, and a MAC address of the smart camera, respectively.

The data transmission 302 is processed by a ML component 304 to identify whether the data transmission 302 is indicative of an anomaly 306 or whether the data transmission 302 is not indicative of an anomaly 308. As the skilled person will appreciate, the ML component 304 may implement any suitable ML algorithm for classification of input data, such as the random forest or k-nearest neighbor (k-NN) techniques.

In FIG. 4, the ML component 304 processes solely the data transmission 304 itself. However, in other examples, the ML component 304 (or another suitable approach for anomaly detection) may additionally process further data, such as traffic data indicative of network traffic activity associated with a plurality of data transmission transmitted via the network of the processor-controlled device (which is the gateway in this example). For example, the traffic data may represent aggregate data, indicative of the behavior of multiple devices and/or data transmissions on the network. As an example, the traffic data may indicate the bandwidth associated with particular data transmissions sent to and/or from the processor-controlled device.

The ML component 304 of FIG. 4 has been trained prior to use of the ML component 304 for identification of anomalies. For example, a training set of data transmissions including identified anomalies (as well as data transmissions that are not anomalous) may be processed using the ML component 304, with parameters of the ML component 304 iteratively adjusted during processing of the training set so that the ML component 304 identifies anomalies with increasing accuracy as training continues. In this way, the ML component 304 can learn what is likely to constitute an anomaly in a data transmission and, in some cases, the conditions in which anomalies occur (e.g. if the ML component 304 is trained using a training set of further data, such as traffic data, as a further input in addition to the data transmission).

If the ML component 304 identifies that no anomaly 308 is present, no further action is taken. If, however, the ML component 304 identifies that the data transmission 302 is anomalous 306, the data transmission 302 is processed by a type detection component 310 configured to identify a type of anomaly present in the data transmission 302. The type detection component 310 may for example include a further ML component configured to identify the type of anomaly, or may use another detection process, such as a rule-based approach. If the type detection component 310 includes a further ML component, the further ML component may be trained in a similar manner to the training of the ML component 304, but to identify anomaly types rather than whether an anomaly is present.

In FIG. 4, the type detection component 310 is configured to classify the anomaly into one of seven different anomaly types 312: abnormal IP address use, abnormal port use, abnormal packet size, abnormal payload size, abnormal bandwidth use, abnormal payload (e.g. abnormal cleartext payload) and other. However, in other examples, other anomaly types may be detected by a ML system otherwise similar to the ML system 300 of FIG. 4.

After identifying the type of anomaly present in the data transmission 302, the ML system 300 of FIG. 4 is configured to perform anomalous portion identification 314, in which a first portion of the data transmission 302 indicative of the anomaly is identified. The anomalous portion identification 314 for example involves identifying that the first portion of the data transmission is relevant to the type of anomaly identified by the type detection component 310. This may for example involve a rule-based approach. For example, if the anomaly type is detected as “abnormal port use”, there may be a rule specifying that the first portion of the data transmission 302 is therefore a portion of the data transmission relating to port use (e.g. the source and destination port fields of the data transmission 302). This is merely an example, though, and it is to be appreciated that other techniques may be used to identify the first portion of the data transmission that is indicative of an anomaly, such as ML techniques.

In some cases, the first portion of the data transmission 302 is identified based further on an access policy associated with the remote system to which the first portion of the data transmission 302 is to be sent for identification of malicious behavior. For example, an access policy may indicate which devices and/or analysts will have access to the first portion of the data transmission at or via the remote system. The access policy may also depend on the type of anomaly detected. For example, the access policy may indicate that a team of security analysts are to have access to the first portion of the data transmission and the anomaly is abnormal port use. Based on the access policy, it can be determined which portions of the data transmission 302 are to be included in the first portion. For example, certain remote systems may be associated with greater security clearance than otherwise. A larger proportion of the data transmission 302 may hence be included in the first portion for those remote systems than for other remote systems, which are considered less secure. Similarly, if the data transmission 302 is to be analyzed for a particular type of malicious behavior, portions of the data transmission 302 that are irrelevant for the detection of that type of malicious behavior may be omitted from the first portion.

In such cases, the processor-controlled device may determine the access policy for the remote system (e.g. based on the type of anomaly identified), and use the access policy to determine which portions of the data transmission 302 are to be included in the first portion. For example, if the processor-controlled device identifies that the anomaly relates to “abnormal port use”, the processor-controlled device may identify that a particular remote system, subsystem of a remote system and/or user of a remote system is to be given access to the first portion to investigate whether it constitutes malicious behavior (e.g. such as a particular subsystem that relates to the investigation of “abnormal port use”). Portions of the data transmission 302 that are unlikely to be useful to a particular subsystem with this specialism may therefore be excluded from the first portion, and may hence be anonymized if they include personal data. In contrast, if the anomaly is identified as “other”, this may indicate that the anomaly is more unusual, which may mean that investigation by a more specialized subsystem is desirable. In such cases, a greater proportion of the data transmission 302 may be included as the first portion, e.g. if the more specialized subsystem has greater security clearance than the subsystem for investigation of “abnormal port use”.

In some examples involving use of an ML system such as the ML system 300 of FIG. 4, each of a plurality of portions of the data transmission 302 are associated with a respective weight. For example, each field of the data transmission 302 of FIG. 4 may be associated with a respective weight. In some cases, the values of the weights are selected such that the sum of all the values is one. Initially, each weight may take a predefined value (e.g. each weight may take the same value as each other). However, during training of an ML component of the ML system, such as the ML component 304 of FIG. 4, the weights may be adjusted in order to increase the efficiency of anomaly detection. For example, after training, certain portions of the data transmission 302 may be associated with a larger weight than others, to give greater significance to those portions in the identification of anomalies. In this way, the weights for example correspond to trainable parameters of the ML component 304.

The values of the weights (e.g. as defined, selected or adjusted) may depend on the type of user device involved in sending or receiving the data transmission 302 and/or the type of attack or other threat the network of the processor-controlled device is considered vulnerable to or has experience. For example, at least one portion of the data transmission (e.g. at least one field of a packet) may be associated with a higher value than another portion of the data transmission, to reflect that the at least one portion of the data transmission is more useful in identifying a particular type of threat.

In the example in which a network or user device is vulnerable to “abnormal port use”, the portions of the data transmission associated with relatively higher weight values are those corresponding to the source and destination ports (which may for example be identified as corresponding to the first portion of the data transmission, indicative of an anomaly, if the data transmission is identified as indicating abnormal port use). For example, the portions of the data transmission corresponding to the source and destination ports may each be associated with a weight value of 0.225, respectively, the portions of the data transmission corresponding to the payload size and the protocol used to encrypt the payload may each be associated with a weight value of 0.025, respectively, and the remaining portions of the data transmission (the source IP address, the destination IP address, the payload content, the packet size and the MAC address of the user device, in an example in which the data transmission is of the same format as the data transmission 302 of FIG. 4) may each be associated with a weight value of 0.125, respectively. In these cases, processing the data transmission using the ML system may involve processing each of the plurality of portions of the data transmission using the respective weight, e.g. to weight the portions using the respective weights.

After identifying the first portion of a data transmission that is indicative of an anomaly, examples herein involve the generation of a modified data transmission. FIGS. 5a and 5b are schematic diagrams illustrating the treatment of various portions of two of the data transmissions of FIG. 3 (the anomalous data transmissions 202) to generate a modified data transmission.

In this example, the first portion of the data transmission does not undergo anonymization, so as to preserve the first portion of the data transmission for further analysis and/or investigation. However, a second portion of the data transmission, which is different from the first portion and comprises personal data, is anonymized. Anonymization for example involves modifying the second portion of the data transmission so as to disguise or otherwise obfuscate the personal data. Anonymizing the personal data for example means that, even if a malicious party were to gain access to the personal data, they would be unable to extract or infer the original personal data from the anonymized version of the personal data.

In some examples, modification of the data transmission involves selective encryption of one or more portions of the data transmission, such that at least the first portion of the data transmission is encrypted. In some of these examples, the selective encryption may be performed without encrypting the anonymized second portion of the data transmission, to reduce the amount of processing performed. Encrypting the first portion of the data transmission allows the modified data transmission (which in these examples includes the encrypted first portion) to be transmitted securely to the remote system, without risking exposure of the first portion to malicious parties.

In some cases, the first portion of the data transmission is encrypted using attribute-based encryption. The attribute-based encryption may involve encrypting the first portion based on the access policy associated with the remote system (as discussed further above). The access policy in such cases is for example based on attributes, which are used to control access to the modified data transmission sent to the remote system (which includes the encrypted first portion in this case). For example, where the data transmissions are packets, different packets and/or different fields of a packet may be encrypted using different keys, which are shared with different subsystems of the remote system depending on the access policy associated with the respective subsystem. In such cases, the different packets and/or fields may be encrypted using the same or different encryption protocols. In general, it is to be appreciated that other encryption protocols than attribute-based encryption may be used to encrypt the first portion based on an access policy in other examples.

A third portion of the data transmission, different from the first and second portions of the data transmission and including non-personal data, may also be identified. The third portion may for example represent non-sensitive data that is not indicative of an anomaly and is therefore of lesser use for further analysis to identify malicious behavior. The third portion of the data transmission may be left as it is (i.e. without undergoing anonymization and/or encryption), as access to the third portion by a malicious party may be considered not to compromise the security of the data transmission, the system and/or network. This approach for example reduces processing demands compared to performing further processing of the third portion (e.g. to perform anonymization and/or encryption).

In some cases, however, the third portion of the data transmission may already be encrypted or may be encrypted by the processor-controlled device. In some of these cases, the first portion is encrypted using a first encryption protocol, such as attribute-based encryption, and the third portion is encrypted using a second encryption protocol, different from the first encryption protocol, such as the transport layer security (TLS) encryption protocol.

Using a different encryption protocol for the first and third portions for example allows the first and third portions to be distinguished from each other by a remote system upon receipt of the modified data transmission. For example, the remote system may receive, from a processor-controlled device, a received data transmission (corresponding to the modified data transmission), which is associated with a data transmission transmitted via a network of the processor-controlled device. In such cases, the received data transmission for example includes data derived from a first portion of the data transmission (which is e.g. indicative of an anomaly) and an anonymized second portion of the data transmission. The data derived from the first portion of the data transmission is for example the first portion itself or data otherwise obtained using the first portion. In the example in which the first portion is encrypted by the processor-controlled device, the data derived from the first portion is for example an encrypted version of the first portion. The received data transmission is indicative that the data derived from the first portion of the data transmission is for use in identifying malicious behavior (e.g. as explained further with reference to FIG. 2). In some examples, it is the format of the data derived from the first portion that is indicative that the data derived from the first portion is for use in identifying malicious behavior (e.g. whether the data derived from the first portion is an encrypted version of the first portion, encrypted using a predetermined encryption protocol such as attribute-based encryption). In this way, the first portion can be distinguished from other portions of the data transmission, such as the second portion (which is not encrypted) and the third portion (if present), which may not be encrypted or may be encrypted using a different encryption protocol.

It is to be appreciated that, in some examples, if the data derived from the first portion represents an encrypted version of the first portion, the remote system (or another computer system that receives the received data transmission via the remote system) decrypts the encrypted version of the first portion to generate a decrypted version of the first portion, and then processes the decrypted version of the first portion to identify whether the first portion is indicative of malicious behavior. To decrypt the encrypted version of the first portion, the remote system obtains an appropriate decryption key. For example, if the first portion is encrypted using attribute-based encryption, at least one attribute associated with the remote system (e.g. of the remote system or a user of the remote system) is for example sent to a key management service. If the at least one attribute complies with the access policy (for example, with reference to the example above, if the at least one attribute indicates that the team associated with the remote system is a team of security analysts to investigate threats of the type “abnormal port use”), a decryption key is generated by the key management service. The generated decryption key is then sent to the remote system, where it can be used to decrypt the encrypted version of the first portion.

Turning back to the generation of the modified data transmission, in some examples the modification of a data transmission to generate the modified data transmission is performed using predetermined rules, which may be adjusted based on the anomaly detection process (e.g. such as that described with reference to FIG. 4). An example of predetermined rules for modifying a data transmission of a particular format is as follows:

| | Encrypt | Anonymize | Leave “as is” |
|---|---|---|---|
| Source IP address | | X | |
| (egress traffic) | | | |
| Source IP address | X | | |
| (ingress traffic) | | | |
| Source Port | | X | |
| (egress traffic) | | | |
| Source Port | X | | |
| (ingress traffic) | | | |
| Destination Port | | X | |
| (ingress traffic) | | | |
| Destination Port | X | | |
| (egress traffic) | | | |
| Payload contents | | | X |
| Payload size | | | X |
| Protocol used | X | | |
| Packet size | | | X |
| MAC address | | X | |

In other words, according to these rules, the source IP address, source port (for ingress traffic), destination port (for egress traffic) and the encryption protocol used to encrypt the payload contents are treated as the first portion of the data transmission (potentially indicative of an anomaly). The source IP address for egress traffic, the source port for egress traffic, the destination port for ingress traffic and the MAC address are considered to be sensitive, and are treated as personal data forming the second portion of the data transmission. The payload contents, the payload size and the packet size are considered neither personal nor potentially indicative of an anomaly, and are therefore treated as the third portion of the data transmission. In this case, the first portion is encrypted, the second portion is anonymized, and the third portion is untreated (i.e. left “as is”).

As explained above, these predetermined rules may be adjusted or otherwise overwritten depending on the type of anomaly detected. In the example above in which the anomaly type is “abnormal port use”, all fields of a data transmission are treated according to the predetermined rules, except the source port for egress traffic and the destination port for egress traffic, which are identified as being potentially indicative of an anomaly. In this case, the fields of the data transmission corresponding to the source port for egress traffic and the destination port for egress traffic are included in the first portion (rather than the second portion) and are hence encrypted rather than being anonymized. It can hence be seen that in some cases in which the second portion includes personal data, the first portion may include further personal data (which is for example different from the personal data in the second portion). With this approach, the provision of unanonymized personal data to the remote system can be reduced, while still allowing the remote system to have access to sufficient data in order to determine whether behavior is malicious or not.

As another example, the MAC address may be considered to be personal data as it may reveal the identity of the user device involved in the data transmission. However, if it is identified that the MAC address is potentially indicative of an anomaly (e.g. if it is determined that the MAC address may have been spoofed by a malicious party to hide their presence), then the MAC address can be included in the first portion rather than second portion, and encrypted rather than anonymized. The modified data transmission including the first portion (in encrypted form) can then be sent to the remote system to allow a determination to be made as to whether the behavior is indeed malicious.

FIG. 5a shows the fourth data transmission of FIG. 3 after modification (indicated with the reference numeral 400a). In examples such as that of FIG. 5a, the first portion comprises at least one field of a packet and the second portion comprises at least one field of the packet. In this example, the modified data transmission includes three portions. The first portion comprises first, second and fourth fields, 402a, 402b, 402d of a packet (which correspond to a source IP address, a source port and a destination port), the second portion comprises a third field 402c of the packet (which corresponds to the destination IP address) and the third portion comprises a fifth field 402e (which corresponds to the payload). The first portion in this example is encrypted (without anonymization), the second portion is anonymized and the third portion has not been treated (but was previously encrypted using a different encryption protocol than that used to encrypt the first portion).

FIG. 5b shows the fifth data transmission of FIG. 3 after modification (indicated with the reference numeral 400b). The first portion comprises second, third and fourth fields, 402b′, 402c′, 402d′ of a packet (which correspond to a source port, a destination IP address and a destination port), the second portion comprises a first field 402a′ of the packet (which corresponds to the source IP address) and the third portion comprises a fifth field 402e′ (which corresponds to the payload). As for the example in FIG. 5a, in FIG. 5b, the first portion in this example is encrypted (without anonymization), the second portion is anonymized and the third portion has not been treated (but was previously encrypted using a different encryption protocol than that used to encrypt the first portion).

As can be seen, the fourth data transmission 400d (shown in FIG. 5a) represents data transmitted to the user device (the smart camera in this example). The destination IP address indicates the IP address of the user device, which is personal data. The third field 402c, representing the destination IP address, is therefore anonymized for the fourth data transmission 400d. In contrast, the fifth data transmission 400e (shown in FIG. 5e) represents data transmitted from the user device. In this case, it is the source IP address that indicates the IP address of the user device. Hence, the first data field 402a′, representing the source IP address, which is anonymized for the fifth data transmission 400e.

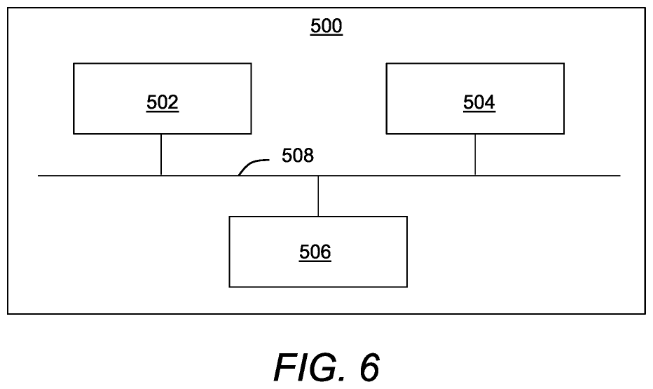

FIG. 6 is a schematic diagram of internal components of a data processing system 500 that may be used in any of the methods described herein. The data processing system 500 may include additional components not shown in FIG. 6; only those most relevant to the present disclosure are shown. The data processing system 500 may be or form part of a processor-controlled device (e.g. a gateway), a remote system or a further computing system. The data processing system 500 in FIG. 5 is implemented as a single computer device but in other cases a data processing system may be implemented as a distributed system.

The data processing system 500 includes storage 502 which may be or include volatile or non-volatile memory, read-only memory (ROM), or random access memory (RAM). The storage 502 may additionally or alternatively include a storage device, which may be removable from or integrated within the data processing system 500. For example, the storage 502 may include a hard disk drive (which may be an external hard disk drive such as a solid state disk) or a flash drive. The storage 502 is arranged to store data, temporarily or indefinitely. The storage 502 may be referred to as memory, which is to be understood to refer to a single memory or multiple memories operably connected to one another.

The storage 502 may be or include a non-transitory computer-readable medium. A non-transitory computer-readable storage medium includes, but is not limited to, volatile memory, non-volatile memory, magnetic and optical storage devices such as disk drives, magnetic tape, compact discs (CDs), digital versatile discs (DVDs), or other media that are capable of storing code and/or data.

The data processing system 500 also includes at least one processor 504 which is configured to implement the methods described herein. The at least one processor 504 may be or comprise processor circuitry. The at least one processor 504 is arranged to execute program instructions and process data. The at least one processor 504 may include a plurality of processing units operably connected to one another, including but not limited to a central processing unit (CPU) and/or a graphics processing unit (GPU). For example, the at least one processor 504 may cause the methods to be implemented upon processing suitable computer program instructions stored in the storage 502.

The data processing system 500 further includes a network interface 506 for connecting to at least one network, such as the local network and the Internet 108 discussed with reference to FIG. 1. A data processing system otherwise similar to the data processing system 500 of FIG. 6 may additionally include at least one further interface for connecting to at least one further component. The components of the data processing system 500 are communicably coupled via a suitable bus 508.

Further examples are envisaged. In the example of FIGS. 1 and 2, the security analysts 116 identify whether the first portion of the data transmission indicates anomalous behavior. However, in other examples, this identification is instead performed by the remote system 114 itself. In such cases, the remote system 114 need not send the modified data transmission 112 to a further entity, such as the security analysts 116.

In examples above, the modified data transmission is sent to a remote system 114, which is configured to identify malicious behavior. It is to be appreciated that the processing performed by the remote system 114 in examples herein may be performed by another or a different computer system in other examples.

As explained above, in some cases a plurality of received data transmissions (e.g. each corresponding to a different respective modified data transmission) are processed to identify malicious behavior. For example, a first received data transmission received from a first processor-controlled device (and associated with a first transmission transmitted via a network of the processor-controlled device) and a second received transmission received from a second processor-controlled device (and associated with a second transmission transmitted via the network of the processor-controlled device may be processed to identify malicious behavior. The first and second received data transmissions may be processed separately, to separately identify malicious behavior of the first and second processor-controlled devices. In other cases, though, identification of malicious behavior of a single one of the first and second processor-controlled devices may depend on both the first and second received data transmissions. Each of the first and second received data transmissions may be similar to the received data transmission described above, but received from a first and second processor-controlled device. This principle may equally be applied to received data transmissions received from a plurality of different processor-controlled devices.

In the example of FIG. 4, an ML system 300 including an ML component 304 and a type detection component 310 is used for anomaly detection. In other examples, there may be an ML architecture such as a suitably-trained autoencoder configured to perform the functionality of the ML component 304 and the type detection component 310, e.g. so as to identify the type of anomaly present in a particular data transmission. In further examples, an ML architecture may output an identification of the first portion of the data transmission that is indicative of an anomaly (and/or that is most indicative of an anomaly), instead of outputting the type of anomaly present and/or whether the data transmission is anomalous.

In yet further examples, ML need not be used to identify the first portion of the data transmission indicative of an anomaly. For example, the first portion of the data transmission may instead be identified on the basis of receiving a particular alert, such as a firewall alert, by a particular security system. In such cases, different alerts may be taken as indicative of anomalies in different respective portions of a data transmission, allowing anomalous portions of respective data transmissions to be easily identified.

Further examples relate to a computer-readable medium storing thereon instructions which, when executed by a computer, cause the computer to carry out the method of any of the examples described herein.

Each feature disclosed herein, and (where appropriate) as part of the claims and drawings may be provided independently or in any appropriate combination. Any apparatus feature may also be provided as a corresponding part of a method, and vice versa.

In general, it is noted herein that while the above describes examples, there are several variations and modifications which may be made to the described examples without departing from the scope of the appended claims. One skilled in the art will recognize modifications to the described examples.

Any reference numerals appearing in the claims are for illustration only and shall not limit the scope of the claims. As used throughout, the word ‘or’ can be interpreted in the exclusive and/or inclusive sense, unless otherwise specified.

1. A method comprising, at a processor-controlled device of a network:
identifying a first portion of a data transmission transmitted via the network that is indicative of an anomaly;
identifying a second portion of the data transmission comprising personal data, the second portion different from the first portion;
modifying the data transmission to generate a modified data transmission, modifying the data transmission comprising selectively anonymizing one or more portions of the data transmission such that at least the second portion of the data transmission is anonymized; and
sending the modified data transmission to a remote system for identification of whether the first portion of the data transmission is indicative of malicious behavior.

2. The method of claim 1, wherein modifying the data transmission comprises selectively encrypting one or more portions of the data transmission such that at least the first portion of the data transmission is encrypted.

3. The method of claim 2, further comprising identifying a third portion of the data transmission, different from the first portion and the second portion of the data transmission, wherein the first portion of the data transmission is encrypted using a first encryption protocol, and the third portion of the data transmission is encrypted using a second encryption protocol, different from the first encryption protocol.

4. The method of claim 2, wherein the first portion of the data transmission is encrypted using attribute-based encryption.

5. The method of claim 1, wherein the first portion of the data transmission comprises further personal data.

6. The method of claim 1, wherein the data transmission is transmitted via the network to or from a user device of the network.

7. The method of claim 1, wherein the processor-controlled device is a gateway of the network.

8. The method of claim 1, wherein the data transmission comprises a packet, the first portion of the data transmission comprises a first field of the packet and the second portion of the data transmission comprises a second field of the packet, different from the first field.

9. The method of claim 1, further comprising, after sending the modified data transmission to the remote system, receiving, from the remote system, an indication that a determination has been made that the data transmission is indicative of malicious behavior.

10. The method of claim 1, wherein identifying the first portion of the data transmission comprises processing the data transmission using a machine learning system implemented by the processor-controlled device.

11. The method of claim 10, wherein identifying the first portion of the data transmission comprises processing the data transmission, and traffic data indicative of network traffic activity associated with a plurality of data transmissions transmitted via the network, using the machine learning system.

12. The method of claim 10, wherein the machine learning system is configured to determine, upon processing the data transmission, a type of anomaly present in the data transmission, and identifying the first portion of the data transmission comprises identifying that the first portion of the data transmission is relevant to the type of anomaly.

13. The method of claim 10, wherein the data transmission comprises a plurality of portions, comprising the first portion and the second portion, each of the plurality of portions associated with a respective weight, and processing the data transmission using the machine learning system comprises processing each of the plurality of portions using the respective weight.

14. The method of claim 1, comprising identifying the first portion of the data transmission based further on an access policy associated with the remote system.

15. A computer-implemented method comprising:
receiving, from a processor-controlled device of a network, a received data transmission associated with a data transmission transmitted via the network, the received data transmission comprising:
data derived from a first portion of the data transmission, and
an anonymized second portion of the data transmission,
wherein the received data transmission is indicative that the data derived from the first portion of the data transmission is for use in identifying malicious behavior;
processing the data derived from the first portion of the data transmission to identify that the first portion of the data transmission is indicative of malicious behavior; and
sending, to the processor-controlled device, an indication that the first portion of the data transmission is indicative of the malicious behavior.

16. The method of claim 15, wherein a format of the data derived from the first portion of the data transmission is indicative that the data derived from the first portion of the data transmission is for use in identifying malicious behavior.

17. The method of claim 16, wherein the data derived from the first portion of the data transmission is an encrypted version of the first portion of the data transmission, encrypted using a predetermined encryption protocol, and the data derived from the first portion of the data transmission is identified as being for use in identifying malicious behavior based on identifying that the first portion of the data transmission is encrypted using the predetermined encryption protocol.

18. The method of claim 17, wherein the predetermined encryption protocol is attribute-based encryption.

19. The method of claim 17, wherein processing the data derived from the first portion of the data transmission comprises decrypting the encrypted version of the first portion of the data transmission to generate a decrypted version of the first portion of the data transmission, and processing the decrypted version of the first portion of the data transmission to identify that the first portion of the data transmission is indicative of the malicious behavior.

20. The method of claim 17, wherein the received data transmission comprises a third portion encrypted using a further encryption protocol different from the predetermined encryption protocol.

21. The method of claim 15, wherein the data transmission is a first data transmission, the received data transmission is a first received data transmission received from a first processor-controlled device, and the method further comprises:
receiving, from a second processor-controlled device of the network, a second received data transmission associated with a second data transmission transmitted via the network, the second received data transmission comprising:
data derived from a first portion of the second data transmission, and
an anonymized second portion of the second data transmission,
wherein the second received data transmission is indicative that the data derived from the first portion of the second data transmission is for use in identifying malicious behavior,
wherein processing the data derived from the first portion of the first data transmission comprises processing the data derived from the first portion of the first data transmission and the data derived from the first portion of the second data transmission to identify that the first portions of the first and second data transmissions are indicative of malicious behavior, and
wherein the method further comprises sending, to the second processor-controlled device, an indication that the first portion of the second data transmission is indicative of the malicious behavior.

22. A processor-controlled device comprising:
at least one processor; and
storage comprising computer program instructions which, when processed by the at least one processor, cause the processor-controlled device to:
identify a first portion of a data transmission transmitted via the network that is indicative of an anomaly;
identify a second portion of the data transmission comprising personal data, the second portion different from the first portion;
modify the data transmission to generate a modified data transmission, the modifying the data transmission comprising selectively anonymizing one or more portions of the data transmission such that at least the second portion of the data transmission is anonymized; and
send the modified data transmission to a remote system for identification of whether the first portion of the data transmission is indicative of malicious behavior.

23. The processor-controlled device of claim 22, wherein the processor-controlled device is a gateway of the network.

24. A computer system comprising:
at least one processor; and
storage comprising computer program instructions which, when processed by the at least one processor, cause the computer system to:
receive, from a processor-controlled device of a network, a received data transmission associated with a data transmission transmitted via the network, the received data transmission comprising:
data derived from a first portion of the data transmission, and
an anonymized second portion of the data transmission,
wherein the received data transmission is indicative that the data derived from the first portion of the data transmission is for use in identifying malicious behavior;
process the data derived from the first portion of the data transmission to identify that the first portion of the data transmission is indicative of identifying malicious behavior; and
send, to the processor-controlled device of the network, an indication that the first portion of the data transmission is indicative of the identifying malicious behavior.

25. A network comprising:
a processor-controlled device comprising:
at least one processor; and
storage comprising computer program instructions which, when processed by the at least one processor, cause the processor-controlled device to:
identify a first portion of a data transmission transmitted via the network that is indicative of an anomaly,
identify a second portion of the data transmission comprising personal data, the second portion different from the first portion,
modify the data transmission to generate a modified data transmission, the modifying the data transmission comprising selectively anonymizing one or more portions of the data transmission such that at least the second portion of the data transmission is anonymized, and
send the modified data transmission to a remote system for identification of whether the first portion of the data transmission is indicative of malicious behavior, and
the computer system of claim 24.
